(19) United States
(12) Patent Application Publication
(10) Pub. No.: US 2013/0166393 A1
(43) Pub. Date: Jun. 27, 2013

(54) ADVERTISEMENT PROVIDING SYSTEM AND METHOD FOR PROVIDING MOBILE DISPLAY ADVERTISEMENT

(71) Applicant: NHN Business Platform Corporation, Seongnam-si (KR)

(72) Inventors: Keonsu LEE, Seongnam-si (KR); Sukku YU, Seongnam-si (KR); Min Kyung SONG, Seongnam-si (KR); Woongsup SHIN, Seongnam-si (KR); Sungho LEE, Seongnam-si (KR); Min Yong JUNG, Seongnam-si (KR); Cheol Oh PARK, Seongnam-si (KR); EunJa BYUN, Seongnam-si (KR)

(73) Assignee: NHN BUSINESS PLATFORM CORPORATION, Seongnam-si (KR)

(21) Appl. No.: 13/683,491

(22) Filed: Nov. 21, 2012

(30) Foreign Application Priority Data
Dec. 26, 2011 (KR) 10-2011-0142864
Jun. 12, 2012 (KR) 10-2012-0062510

(51) Int. Cl. G06Q 30/02

(52) U.S. Cl. CPC G06Q 30/0267
USPC 705/14.69; 705/14.4

(57) ABSTRACT

Provided is an advertisement providing system and method for providing a mobile display advertisement. The advertisement providing method may include receiving an advertisement and displaying the advertisement on a touch display, recognizing a touch gesture generated on the touch display, and displaying additional advertisement information of the advertisement on the touch display based on the recognized touch gesture.

### CROSS-REFERENCE TO RELATED APPLICATIONS

This application claims priority from and the benefit of Korean Patent Application Nos. 10-2011-0142864, filed on Dec. 26, 2011, and 10-2012-0062510, filed on Jun. 12, 2012, both of which are hereby incorporated by reference for all purposes as if fully set forth herein.

### BACKGROUND OF THE INVENTION

1. Field of the Invention

Exemplary embodiments of the present invention relate to an advertising system and method for providing mobile display advertisement.

2. Discussion of the Background

In recent times, the market for mobile advertisement via user terminals as well as via wired media is growing rapidly. Mobile advertisement is a mobile marketing means for delivering advertisements in various forms, such as in the forms of voice, text, video, and the like, to target customers through mobile communications equipment, without constraints of time and space. A mobile advertisement is, in order to be provided, typically embedded in an application or a mobile web for mobile equipment including, for example, smart phones, tablet computers, and the like.

FIG. 1 illustrates an example of a user terminal 110 including a touch display 120 according to related art. In FIG. 1, the user terminal 110 may include the touch display 120, which is, for example, a touch screen, as an input device to receive the input of the location of a recognized touch, and may display an advertising area 130 on the touch display 120. The touch display 120 may recognize a touch on the touch display 120, and when a touch is sensed on the advertising area 130, a landing page of an advertiser may be provided to the user terminal 110 and displayed on the touch display 120.

In this instance, if the cost-per-click (CPC) model, where an advertising cost is incurred when an advertising page is displayed to a user selecting an advertisement, is used, the advertiser is charged an advertising cost when the user selects the displayed advertisement. However, due to the characteristics of the touch display 120, there exists a high possibility that unintended touches on the displayed advertisement often occur. For example, there is a possibility of the user inadvertently touching the advertising area 130 without intending it. Nonetheless, the advertiser is still required to pay the advertising cost that is immaterial to any advertising effects, while the user may suffer an inconvenience due to unwanted advertisement information being provided.

Thus, there is a need for a system and method for providing mobile advertisement in a more efficient manner.

### SUMMARY OF THE INVENTION

Exemplary embodiments of the present invention provide an advertisement providing system and method that may recognize selection of an advertisement by a user using a touch gesture such as a touch drag, other than a simple touch, on an advertising area.

Exemplary embodiments of the present invention also provide an advertisement providing system and method that may provide, when selection of an advertisement by a user is recognized, advertisement information based on a predetermined action set for a touch gesture, beyond simply providing an advertising page.

Exemplary embodiments of the present invention also provide an advertisement providing system and method that may charge advertising costs differently, based on an advertisement selection model used.

Exemplary embodiments of the present invention also provide an advertisement providing system and method that may provide, for one advertisement, advertisement information including various link options, for example, a video link, an application store link, a webpage link, a social networking service (SNS) link, and the like.

Exemplary embodiments of the present invention also provide an advertisement providing system and method that can promote interests of a user by tracking individual link options selected by the user and continuously providing link options attracting a high interest from the user.

Additional features of the invention will be set forth in the description which follows, and in part will be apparent from the description, or may be learned by practice of the invention.

An exemplary embodiment of the present invention discloses an advertisement providing method including receiving an advertisement and displaying the advertisement on a touch display, recognizing a touch gesture generated on the touch display, and displaying additional advertisement information of the advertisement on the touch display based on the recognized touch gesture.

Another exemplary embodiment of the present invention discloses an advertisement providing method including maintaining an advertisement including a function for controlling a user terminal, and providing the advertisement to the user terminal or a publisher accessed by the user terminal, and the function may include, when the advertisement is displayed on a touch display of the user terminal, a function for controlling the user terminal to display additional advertisement information of the advertisement by recognizing a touch gesture generated on the touch display.

Still another exemplary embodiment of the present invention discloses an advertisement providing method including receiving at least one advertisement from an advertising platform in response to an access request from a user terminal, and providing the user terminal with a page including a function for controlling the user terminal along with the advertisement in response to the access request, and the function may include, when the advertisement is displayed on a touch display of the user terminal, a function for controlling the user terminal to display additional advertisement information of the advertisement by recognizing a touch gesture generated on the touch display.

Yet another exemplary embodiment of the present invention discloses a non-transitory computer-readable storage medium comprising instructions for instructing a computer system to provide an advertisement, the instructions controlling the computer system by a method including receiving an advertisement and displaying the advertisement on a touch display, recognizing a touch gesture generated on the touch display, and displaying additional advertisement information of the advertisement on the touch display based on the recognized touch gesture.

Further another exemplary embodiment of the present invention discloses a non-transitory computer-readable storage medium comprising instructions for instructing a computer system to provide an advertisement, the instructions controlling the computer system by a method including maintaining an advertisement including a function for controlling a user terminal, and providing the advertisement to the user terminal or a publisher accessed by the user terminal, and the function may include, when the advertisement is displayed on a touch display of the user terminal, a function for controlling the user terminal to display additional advertisement information of the advertisement by recognizing a touch gesture generated on the touch display.

Still another exemplary embodiment of the present invention discloses a non-transitory computer-readable storage medium comprising instructions for instructing a computer system to provide an advertisement, the instructions controlling the computer system by a method including receiving at least one advertisement from an advertising platform in response to an access request from a user terminal, and providing the user terminal with a page including a function for controlling the user terminal along with the advertisement in response to the access request, and the function may include, when the advertisement is displayed on a touch display of the user terminal, a function for controlling the user terminal to display additional advertisement information of the advertisement by recognizing a touch gesture generated on the touch display.

Still another exemplary embodiment of the present invention discloses an advertisement providing system including an advertisement display unit configured to receive an advertisement and to display the advertisement on a touch display, a touch gesture recognition unit configured to recognize a touch gesture generated on the touch display, and an advertisement information display unit configured to display additional advertisement information of the advertisement on the touch display based on the recognized touch gesture.

Still another exemplary embodiment of the present invention discloses an advertisement providing system including an advertisement maintaining unit configured to maintain an advertisement including a function for controlling a user terminal, and an advertisement providing unit configured to provide the advertisement to the user terminal or a publisher accessed by the user terminal, and the function may include, when the advertisement is displayed on a touch display of the user terminal, a function for controlling the user terminal to display additional advertisement information of the advertisement by recognizing a touch gesture generated on the touch display.

Still another exemplary embodiment of the present invention discloses an advertisement providing system including an advertisement receiving unit configured to receive at least one advertisement from an advertising platform in response to an access request from a user terminal, and an advertisement providing unit configured to provide the user terminal with a page including a function for controlling the user terminal along with the advertisement in response to the access request, and the function may include, when the advertisement is displayed on a touch display of the user terminal, a function for controlling the user terminal to display additional advertisement information of the advertisement by recognizing a touch gesture generated on the touch display.

At least part of the touch gesture may include a touch drag in a predetermined direction.

The touch gesture may include a touch gesture generated on an advertising area of the advertisement displayed on the touch display.

The additional advertisement information may be displayed to be in motion on the touch display, based on at least one value of a direction, an intensity, a speed, and an acceleration of the recognized touch gesture.

The additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement.

The advertisement may include at least one of location information, direction information, and type information for inducing the touch gesture. In this case, the at least one information may be displayed on the touch display along with the advertisement.

An advertising cost may be charged to an advertiser of the advertisement for displaying the additional advertisement information based on the recognized touch gesture.

The additional advertisement information may be displayed on the touch display when a touch generated on the advertising area of the advertisement is recognized. In this case, an advertising cost incurred by recognizing the touch may be different from an advertising cost incurred by recognizing the touch gesture.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating an example of a user terminal including a touch display according to related art.

FIG. 2 is a diagram illustrating an advertisement providing system according to an exemplary embodiment of the present invention.

FIG. 3 is a diagram illustrating an example of a user terminal including a touch display according to an exemplary embodiment of the present invention.

FIG. 4 is a diagram illustrating another example of a user terminal including a touch display according to an exemplary embodiment of the present invention.

FIG. 5 is a diagram illustrating an example of providing additional advertisement information according to an exemplary embodiment of the present invention.

FIG. 6 is a diagram illustrating another example of providing additional advertisement information according to an exemplary embodiment of the present invention.

FIG. 7 is a diagram illustrating an example of displaying large-size advertisement information according to an exemplary embodiment of the present invention.

FIG. 8 is a diagram illustrating an example of an advertisement including a link option according to an exemplary embodiment of the present invention.

FIG. 9 is a diagram illustrating examples of various services provided based on a link option selected according to an exemplary embodiment of the present invention.

FIG. 10 is a diagram illustrating examples of different services provided based on a link option included in an advertisement according to an exemplary embodiment of the present invention.

FIG. 11 is a block diagram illustrating an internal configuration of an advertisement providing system according to an exemplary embodiment of the present invention.

FIG. 12 is a flowchart illustrating an advertisement providing method according to an exemplary embodiment of the present invention.

FIG. 13 is a block diagram illustrating an internal configuration of an advertisement providing system according to another exemplary embodiment of the present invention.

FIG. 14 is a flowchart illustrating an advertisement providing method according to another exemplary embodiment of the present invention.

FIG. 15 is a block diagram illustrating an internal configuration of an advertisement providing system according to still another exemplary embodiment of the present invention.

FIG. 16 is a flowchart illustrating an advertisement providing method according to still another exemplary embodiment of the present invention.

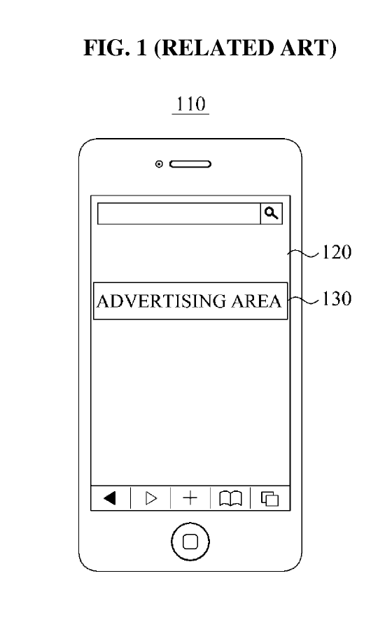

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

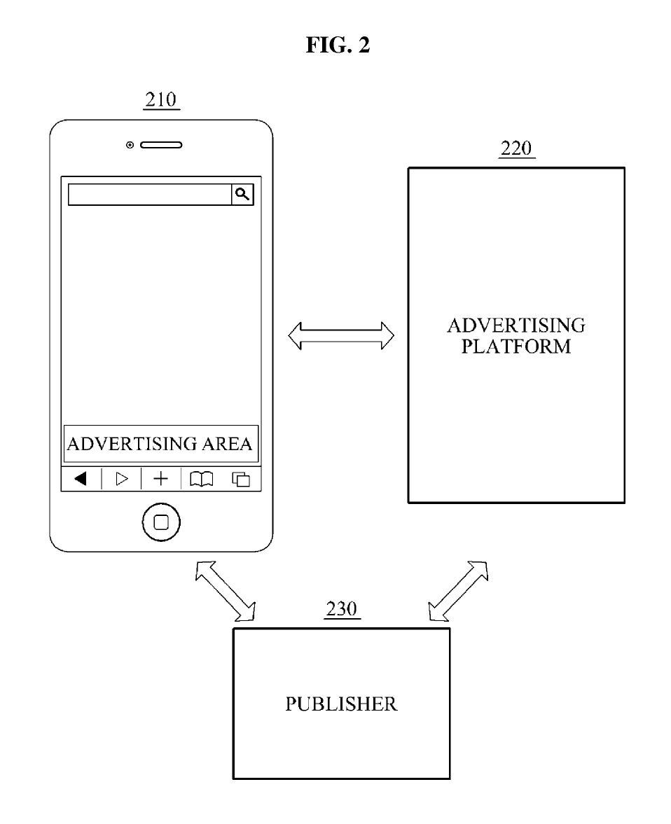

FIG. 2 is a diagram illustrating an advertisement providing system according to an exemplary embodiment of the present invention. In FIG. 2, a user terminal 210, an advertising platform 220, and a publisher 230 are provided.

In accordance with one embodiment, the user terminal 210 may include a touch display, for example, a touch screen, as an input device to receive the input of the location of a recognized touch gesture.

The advertising platform 220 may be a system that executes the operations of advertisement bidding of an advertiser, matching advertisements and keywords, arranging advertisements or advertisers, providing advertisements to the publisher 230, charging advertising costs, and the like. Since the general technical features of the advertising platform 220 can be understood by a person having ordinary skill in the art, no detailed description is made in the present disclosure for conciseness and ease of explanations.

The term “publisher” as stated herein may be used interchangeably with a “website” or may include a “website”. However, the usage of the term “website” in the following description is not intended to limit the scope of the invention. Specifically, embodiments of the present invention may also be implemented in an environment where an application display is provided on a mobile terminal, as well as in an environment where a website is accessed by a general personal computer (PC). Further, the term “website” may correspond to a publishing site or the publisher 230. Here, the “website” may include all types of websites and mobile webpages that can display and provide advertisements to users via a wired/wireless network, and may include one webpage or mobile webpage constituting a website. Applications that may be used according to embodiments of the present invention are any type of programs that deliver content to a computing device, such as smart phones, tablet computers, mobile computing devices, TVs, and the like.

That is, when a user accesses the publisher 230 via the user terminal 210, the publisher 230 may request an advertisement from the advertising platform 220, and the advertisement provided from the advertising platform 220 may be displayed on the user terminal 210 in advertising areas of a website associated with the publisher 230. As another example, the user terminal 210 may request an advertisement from the advertising platform 220 by control of an application installed in the user terminal 210. In this case, the advertising platform 220 may provide an advertisement to the user terminal 210 directly, and, in this case, the advertisement provided from the advertising platform 220 may be displayed in advertising areas associated with the application on the user terminal 210.

In this instance, the advertisement provided by the advertising platform 220 may include a selection verification function. Here, the selection verification function included in the advertisement may include a function for controlling the user terminal 210 to provide additional advertisement information by recognizing a touch gesture generated on the area in which the advertisement is displayed. For example, when the user visits a website of the publisher 230 via the user terminal 210, the advertising platform 220 may provide the advertisement to the publisher 230, and the advertisement may be displayed on the user terminal 210 in advertising areas of the website of the publisher 230. In this instance, the user terminal 210 may display advertisement information associated with the advertisement, in response to recognizing the touch gesture on the touch display from the user.

The term “touch display” as stated herein may correspond to an input device to receive the input of the location of a recognized touch as described in the foregoing. Here, the location of the touch may be recognized by a touch coordinate. Also, the term “touch” as stated herein may include user inputs recognized by one touch coordinate, and the term “touch gesture” as stated herein may include user inputs recognized by a plurality of touch coordinates. In this instance, the touch gesture may also include user inputs recognized by the same touch coordinate multiple times in succession within a predetermined time interval. For example, the touch gesture may include a touch drag as a user input for receiving sequential inputs of a plurality of different touch coordinates, for example, a flip, a flick, and a swipe, and double taps as a user input for receiving sequential inputs of the same touch coordinate. Further, a touch gesture according to one embodiment of the present invention may include a touch that is maintained on the same position for a threshold period of time (e.g., 2 or 3 seconds), as opposed to a simple touch that is not maintained for the threshold period of time.

As another example, the selection verification function may be included in a page including an advertisement, for instance, a page of the publisher, or an application displaying an advertisement. That is, the advertising platform 220 may simply transmit data necessary for displaying an advertisement, and may control the user terminal 210 by use of the selection verification function for controlling the user terminal 210 to display additional advertisement information of the advertisement by recognizing a touch gesture such as a touch drag on the page or the application in which the advertisement is displayed.

Accordingly, by providing additional advertisement information based on a touch gesture to prompt an advertisement, rather than providing a landing page of the advertiser in response to a mere touch on the advertising area, the possibility of incurring advertising costs immaterial to effective advertising caused by inadvertent touch gesture inputs by the user and an unsolicited page being provided to the user can be reduced.

Also, a touch gesture may be variously classified based on the types or the directions thereof, and various forms of advertisement information may be provided based on such classified, various types of touch gestures. That is, different advertisement information may be provided depending on the types of touch gestures. For example, when a touch drag to the left on the advertising area is recognized, the landing page of the advertiser may be provided, and when a touch drag to the right is recognized, an application download page with respect to the advertiser may be provided.

Although the present disclosure may describe only an exemplary embodiment in which advertisement information is provided in response to touch-dragging a button associated with the advertising area in a predetermined direction, for conciseness and ease of explanation, an exemplary embodiment may enable the user to select an advertisement using various touch gestures on the advertising area. For example, an exemplary embodiment may enable the user to select an advertisement through a touch gesture of touch-dragging in a diagonal down-right direction and successively in a diagonal up-right direction within the advertising area.

Also, although the “advertisement” stated herein is described mainly based on display advertisements, the advertisement is not limited to display advertisements. For example, search advertisements including an advertising area for displaying an advertisement may be used so that additional advertisement information of the corresponding advertisement may be provided in response to recognizing a touch drag on the advertising area.

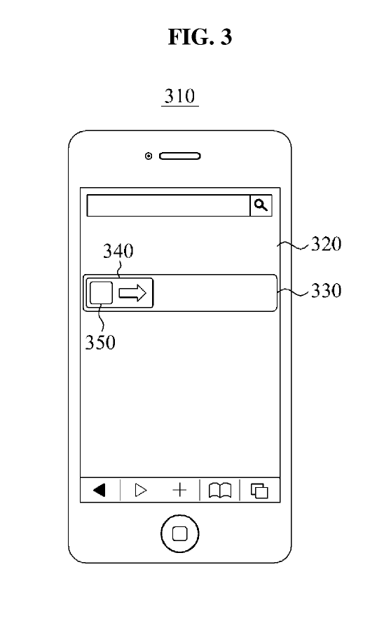

FIG. 3 is a diagram illustrating an example of a user terminal 310 including a touch display 320 according to an exemplary embodiment of the present invention. In FIG. 3, the user terminal 310 is provided. In this instance, the user terminal 310 may include the touch display 320, which may be, for example, a touch screen, as an input device to receive the input of the location of a recognized touch. Also, FIG. 3 illustrates an advertising area 330 displayed on the touch display 320. For example, the advertising area 330 may correspond to the area in which an advertisement is displayed on a page accessed by the user terminal 310 or in which an advertisement is displayed on a predetermine application.

In this instance, the advertisement displayed in the advertising area 330 may include a selection verification function for controlling the user terminal 310 to display additional advertisement information of the advertisement in response to recognizing a touch gesture such as a touch drag on the area in which the advertisement is displayed. A user interface 340 may be displayed on the touch display 320 of the user terminal 310 along with the advertisement by control of the selection verification function. Also, as described in the foregoing, in accordance with one embodiment, the selection verification function may be included in a page or an application including the advertisement, but not in the advertisement.

When the user touch-drags a button 350 included in the user interface 340 in the direction the arrow indicates, the user terminal 310 may display additional advertisement information by control of the selection verification function. That is, by the touch drag, the user terminal 310 may receive additional advertisement information and may display the additional advertisement information on the touch display 320. Here, the additional advertisement information may correspond to an advertising page, such as, for example, a landing page of an advertiser, and an advertising content created separately, such as, for example, an image, video, and the like.

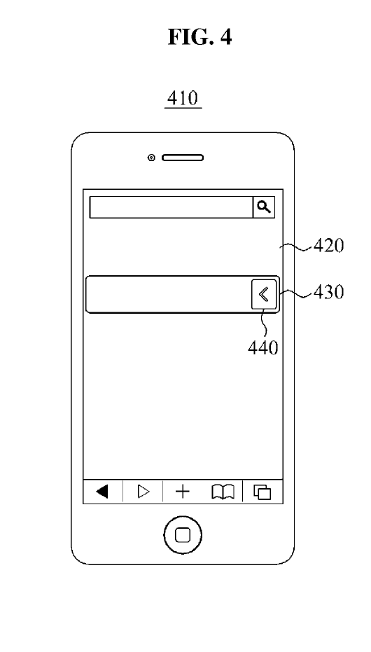

FIG. 4 is a diagram illustrating another example of a user terminal 410 including a touch display 420 according to an exemplary embodiment of the present invention. In FIG. 4, the user terminal 410 is provided. In this instance, the user terminal 410 may include the touch display 420, which may be, for example, a touch screen, as an input device to receive the input of the location of a recognized touch. Also, FIG. 4 illustrates an advertising area 430 displayed on the touch display 420. For example, the advertising area 430 may correspond to the area in which an advertisement is displayed on a page accessed by the user terminal 410 or in which an advertisement is displayed on a predetermine application.

In this instance, the advertisement displayed in the advertising area 430 may include a selection verification function for controlling the user terminal 410 to display additional advertisement information of the advertisement in response to recognizing a touch gesture such as a touch drag on the area in which the advertisement is displayed. A user interface 440 may be displayed on the touch display 420 of the user terminal 410 along with the advertisement by control of the selection verification function. Also, as described in the foregoing, although the selection verification function may be absent in the advertisement, the selection verification function may be included in a page or an application including the advertisement.

When the user touch-drags the user interface 440 in the direction the arrow indicates, the user terminal 410 may display additional advertisement information by control of the selection verification function. That is, in response to the touch drag, the user terminal 410 may receive additional advertisement information and may display the additional advertisement information on the touch display 420. Here, the additional advertisement information may correspond to an advertising page, such as, for example, a landing page of the advertiser, and an advertising content created separately, such as, for example, an image, video, and the like.

Referring to FIG. 3 and FIG. 4, according to the exemplary embodiments of the present invention, advertisement information may be provided based on a predetermined touch gesture, other than a simple, single touch, on an advertising area. That is, if the cost per click (CPC) advertising model, where an advertising cost is incurred by displaying an advertising page in response to a user selecting an advertisement, is employed, the advertiser is charged an advertising cost when the user selects the displayed advertisement. In this instance, if a selection of an advertisement by a user is simply recognized by a single touch on the advertising area, there is a high possibility that the advertisement was selected by an inadvertent touch gesture input by the user. According to the exemplary embodiments of the present invention, by recognizing the selection of an advertisement by the user based on a predetermined touch gesture, rather than a simple touch, the possibility that an advertisement unwanted by a user or an advertiser is displayed can be reduced.

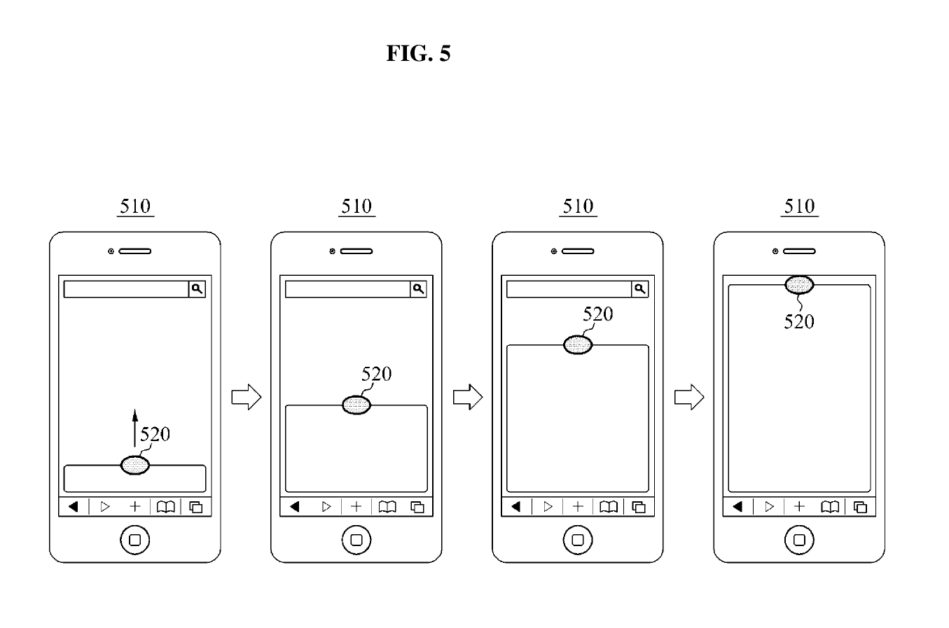

FIG. 5 is a diagram illustrating an example of providing additional advertisement information according to an exemplary embodiment of the present invention. In FIG. 5, additional advertisement information may be provided by a user touch-dragging up a predetermined user interface 520 on a user terminal 510.

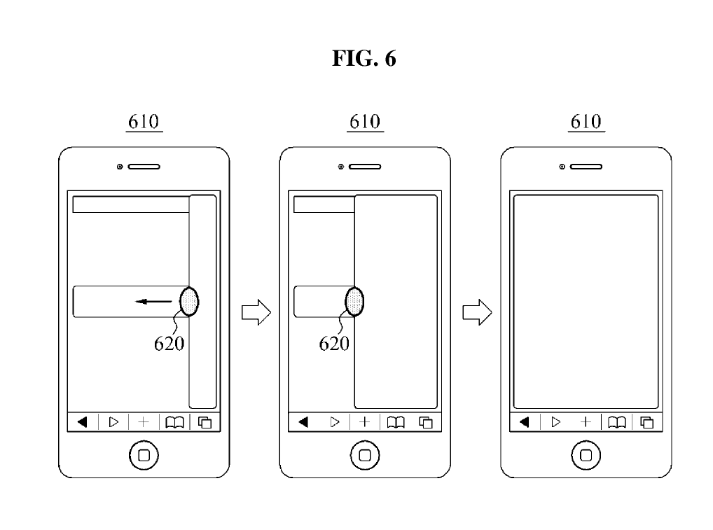

FIG. 6 is a diagram illustrating another example of providing additional advertisement information according to an exemplary embodiment of the present invention. In FIG. 6, additional advertisement information may be provided by a user touch-dragging a predetermined user interface 620 to the left on a user terminal 610.

Referring to FIG. 5 and FIG. 6, additional advertisement information may be displayed overlaid on a page or an application including an advertising area, rather than a separate page. In this instance, the underlying page or application may be displayed again by touch-dragging in the opposite direction. In this case, the location of the additional advertisement information may be controlled in response to recognizing a touch drag on the area in which the additional advertisement information is displayed overlaid.

FIG. 7 is a diagram illustrating an example of displaying large-size advertisement information according to an exemplary embodiment of the present invention. In FIG. 7, large-size advertisement information may be displayed by touch-dragging a predetermined user interface 720 on a user terminal 710 to the left. In this instance, the location of the large-size advertisement information may be moved through the user interface 720 in response to a touch drag on the advertising area in the horizontal direction.

Referring to FIG. 5, FIG. 6, and FIG. 7, the user terminals 510, 610, and 710 may sense at least one value of an intensity, a speed, and an acceleration of a touch drag input by a user, and advertisement information may be moved using the at least one sensed value. That is, the moving intensity, the moving rate, or the acceleration of the advertising information may be determined based on the intensity, the speed, or the acceleration of the touch drag.

In this instance, as shown in FIG. 5, FIG. 6, and FIG. 7, an exemplary embodiment of the present invention may reduce the burden of generating a landing page imposed on advertisers who may not have any separate mobile homepage, by overlaying an image as additional advertisement information without providing a separate landing page.

Also, although FIG. 5, FIG. 6, and FIG. 7 describe only an exemplary embodiment in which an image is overlaid, the present invention is not limited thereto and may be implemented in any manner that a service display currently being displayed is pushed aside by the image being displayed.

Furthermore, the present invention may be implemented so that a previous service display may be rolled back in response to a subsequent touch gesture on the image displayed, which was overlying the service display or pushed aside the service display.

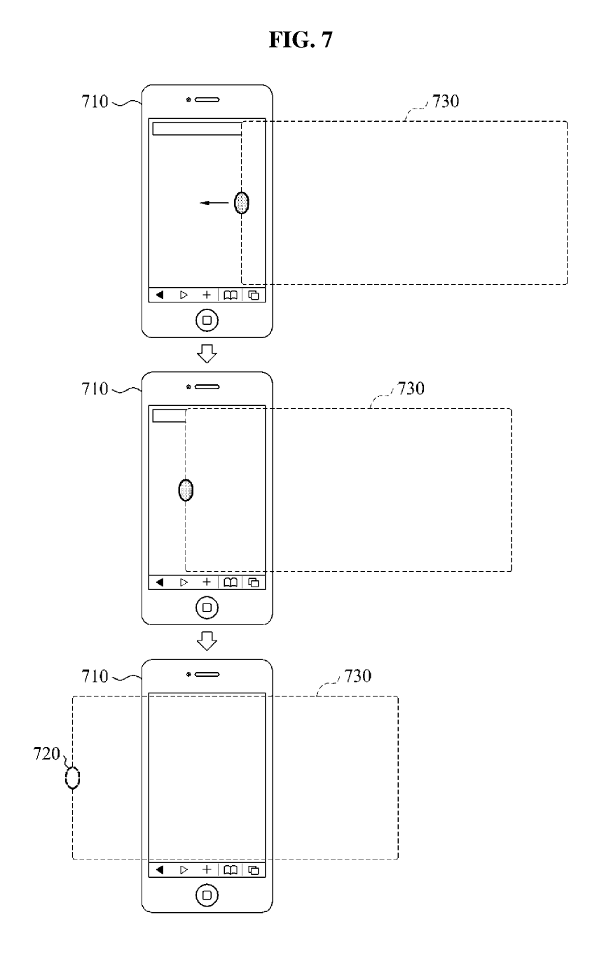

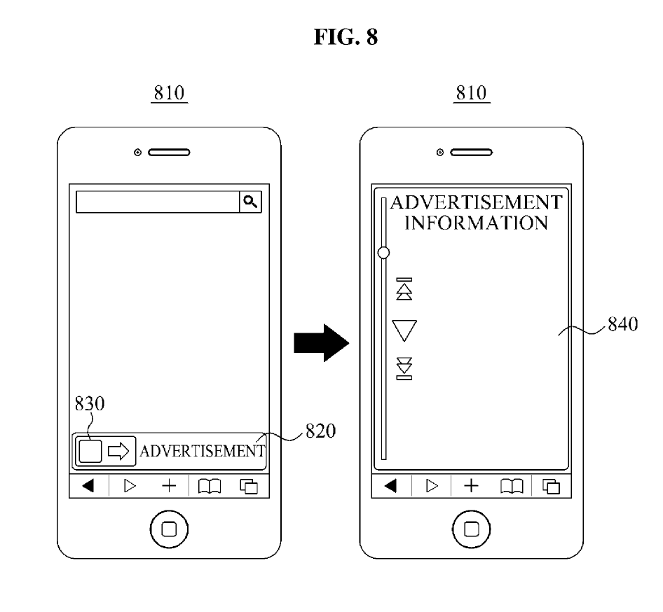

FIG. 8 is a diagram illustrating an example of an advertisement 820 including a link option according to an exemplary embodiment of the present invention. In FIG. 8, the advertisement 820 created in the form of a display advertisement may be displayed on the display of a mobile terminal 810. In this instance, a link option may be set at least in a boxed portion 830 of the advertisement 820. In the terminal illustrated on the right side of FIG. 8, advertisement information 840 created in the form of a video advertisement may be displayed on the display of the mobile terminal 810. That is, in FIG. 8, the advertisement information 840 may be provided in response to the user selecting the boxed portion 830 including a link option by a touch drag. Here, a predetermined icon image set depending on the link option may be displayed on the boxed portion 830.

That is, one of different link options may be set on the boxed portion 830. For example, different link options may include at least two of a link option for a service providing a video associated with the advertisement, a link option for a service providing a landing page associated with the advertisement, a link option for a map service providing location information associated with the advertisement, a link option for a click-to-call service providing a call to a telephone number associated with the advertisement, a link option for a service providing an application associated with the advertisement, and a link option for a social networking service (SNS) associated with the advertisement.

FIG. 9 is a diagram illustrating examples of various services provided based on a link option selected according to an exemplary embodiment of the present invention. In FIG. 9, examples of services provided via link options are illustrated. Here, a “video providing service” may show an example of a display providing a video via a link option included in the advertisement, a “click-to-call service” may show an example of a display providing a call to a telephone number associated with the advertisement, a “map service” may show an example of a display providing location information associated with the advertisement. Also, a “website” may show an example of a display providing a landing page of the advertiser, an “application store” may show an example of a display providing a page from which an application associated with the advertiser may be downloaded, and an “SNS” may show an example of a display providing an SNS page associated with the advertiser.

That is, according to the exemplary embodiments of the present invention, various forms of information or services may be provided to users via various link options. In this instance, various forms of information or services may be provided using a basic function of a user terminal, such as, for example, a smart phone, a tablet computer, a smart TV, and the like.

Also, a link option that is displayed to but is unselected by the user may not be provided to the user afterwards. Instead, another link option may be provided to the user. More specifically, the user's interest can be enhanced by tracking each link option selected by the user, setting a link option attracting a high interest from the user as a link option of interest, and providing advertisements including the link option of interest as default to the user. For example, when a user selects a link option for providing a video the most number of times among different link options provided to the user, the link option for providing a video may be set as a link option of interest to the user. Further, when another advertisement is provided to the user afterwards, the advertisement may include a link option for providing a video in order to provide advertisement information the user would likely be more interested in.

Also, advertisement information that is selected by a user via an advertisement and is displayed to the user at least once may not be displayed to the same user again. That is, advertisement information displayed in response to a touch gesture such as a touch drag, rather than a simple single touch, is more likely advertisement information selected actively by a user who is interested in the information. Accordingly, the effectiveness of advertising can be improved by providing different advertisement information rather than providing the same advertisement information to the same user.

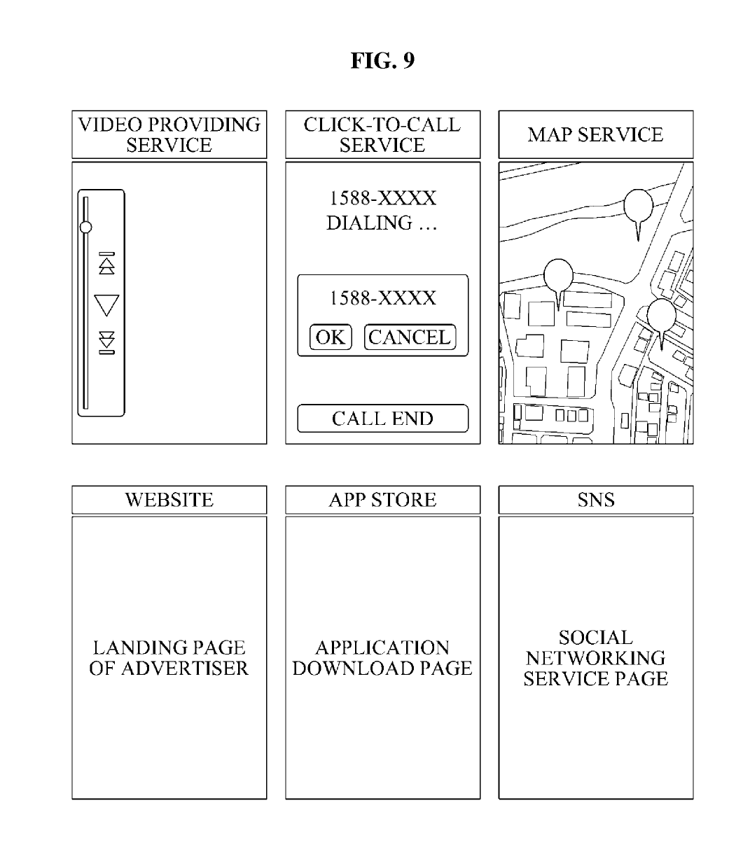

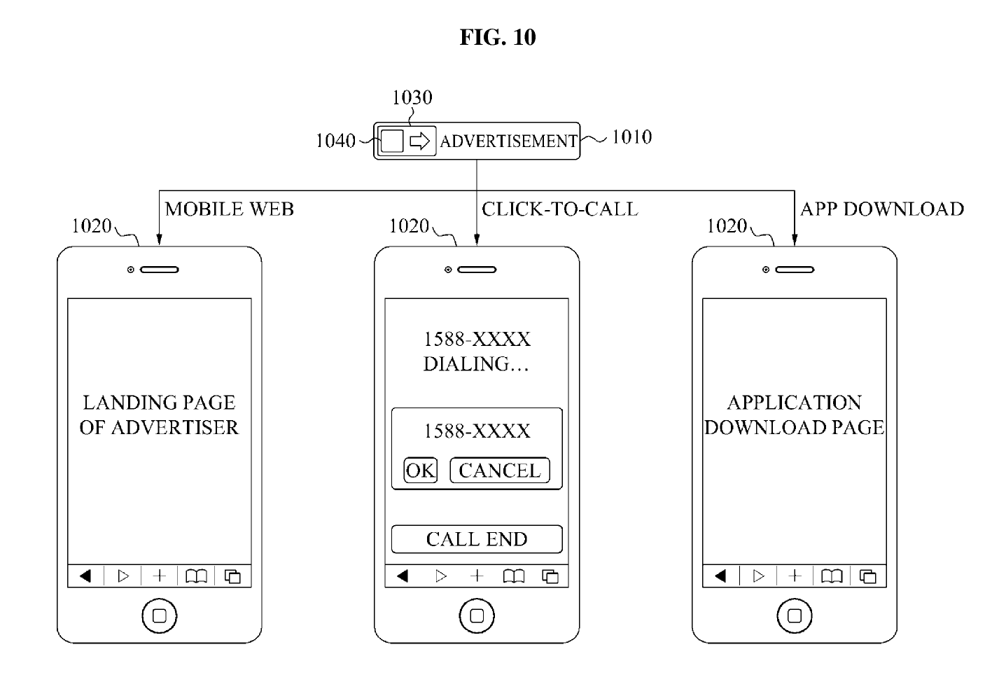

FIG. 10 is a diagram illustrating examples of different services provided based on a link option included in an advertisement 1010 according to an exemplary embodiment of the present invention. The advertisement 1010 may be displayed on the touch display of a user terminal 1020. In this instance, when a user touch-drags a button 1040 in a user interface 1030 displayed along with the advertisement 1010 in the direction of the arrow, a predetermined service may be provided to the user terminal 1020. That is, FIG. 10 illustrates various services that may be provided when different predetermined services are set to respective advertisements on which a touch drag input by the user may occur. In this instance, information about a predetermined link option set to at least one of the user interface 1030 and the button 1040 may be displayed concurrently.

Although the embodiments of FIGS. 3 through 10 show that additional advertisement information is displayed via a touch gesture generated on advertising areas, additional advertisement information associated with the advertisements may be displayed using a touch gesture generated over the entire display area when needed. For example, when one display advertisement is included in one page or one display, additional advertisement information of the corresponding advertisement may be provided by recognizing a touch gesture of the user, irrespective of the advertising area.

Accordingly, when advertisement information is provided to the user, the advertising cost may be charged to the advertiser of the corresponding advertisement for providing the advertisement information. In this instance, the advertisement providing system according to an exemplary embodiment of the present invention may only charge the advertising cost for a user action accepted as an effective click, via a more precise touch gesture than a simple touch. As another example, the advertisement providing system may charge an advertising cost both for a touch action on the advertising area and for a touch gesture action using a user interface displayed along with the advertisement, and in this instance, may charge an extra advertising cost for the touch gesture action. For example, an advertising cost of 100 Won may be charged for displaying a landing page by a simple touch action, and an advertising cost of 150 Won may be charged for displaying a landing page by a touch gesture action.

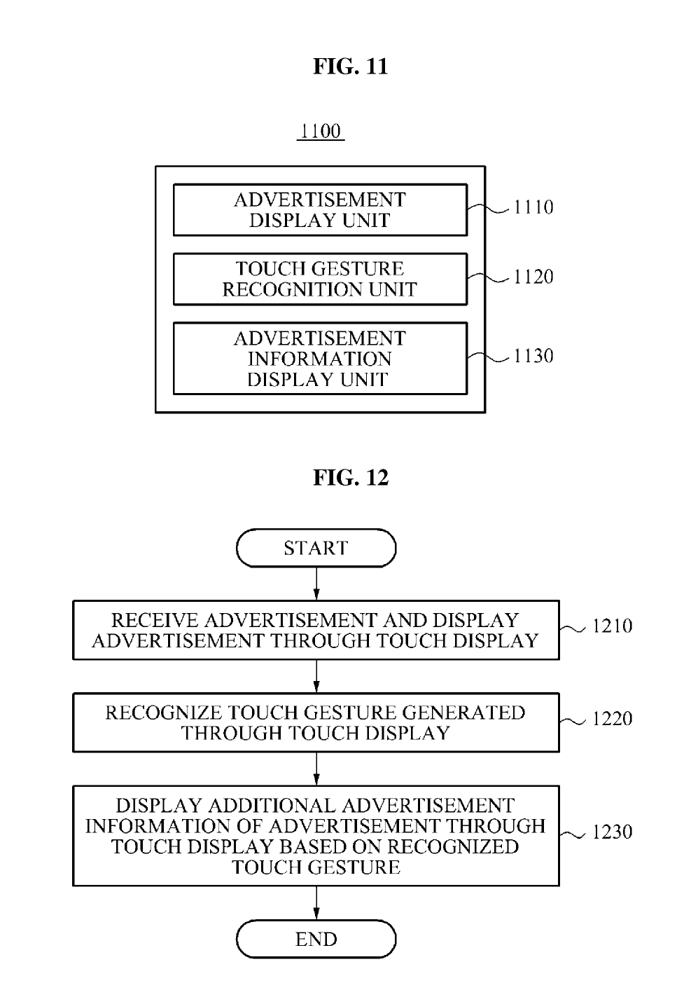

FIG. 11 is a block diagram illustrating an internal configuration of an advertisement providing system 1100 according to an exemplary embodiment of the present invention. The advertisement providing system 1100 according to this exemplary embodiment may correspond to the user terminals 210, 310, 410, 510, 610, 710, 810, and 1020 described with reference to FIGS. 2 through 10. As shown in FIG. 11, the advertisement providing system 100 may include an advertisement display unit 1110, a touch gesture recognition unit 1120, and an advertisement information display unit 1130.

The advertisement display unit 1110 may receive an advertisement and may display the advertisement on a touch display. In this instance, the advertisement may be received from an advertising platform or a publisher. For example, the advertisement received from the publisher may be displayed in the advertising area of a page of the publisher, and the advertisement received from the advertising platform may be displayed in the advertising area of an application installed in the advertisement providing system 1100.

The touch gesture recognition unit 1120 may recognize a touch gesture generated on a touch display. Here, at least part of the touch gesture may include a touch drag in a predetermined direction. That is, a touch drag in a predetermined direction may demonstrate that the user action was taken by the user more deliberately than a simple touch. Accordingly, the possibility of the user action occurring as a result of an inadvertent input by the user is relatively low with respect to a touch gesture. Also, the touch gesture may be limited to a touch gesture generated on the particular advertising area of the advertisement displayed on the touch display. In general, the touch gesture may include a touch gesture generated over the entire area of the touch display. However, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of a touch gesture, and the at least one piece of location information, direction information, and type information may be displayed on the touch display along with the advertisement. For example, the user interface 340 of FIG. 3 may display location information for starting the touch gesture, such as, the button 350, direction information such as the arrow, and type information. That is, the arrow may indicate a touch drag in the direction to the right.

The advertisement information display unit 1130 may display additional advertisement information of the advertisement on the touch display based on the recognized touch gesture. Here, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus, will not be repeated here for conciseness.

Also, the additional advertisement information may be displayed to be in motion on the touch display, based on at least one value of a direction, an intensity, a speed, and an acceleration of the recognized touch gesture. In this case, the additional advertisement information may be displayed in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out and the previous service display may appear again.

When the additional advertisement information is displayed, the advertisement providing system 1100 may charge the advertising cost to the advertiser of the advertisement for displaying the advertisement information based on the recognized touch gesture. That is, the advertising cost may only be charged for displaying advertisement information based on a touch gesture accepted as an effective click. As another example, additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture is likely an advertisement selected more deliberately by the user, a higher advertising cost may be charged in response to recognizing a touch gesture.

As described in the foregoing, a conventional landing page of an advertiser may be provided in response to a simple touch on the advertising area. In this case however, due to the characteristics of a touch display, an issue may be raised regarding the high possibility of a touch unwanted by the user, the advertiser, or both that may have been generated inadvertently by the user. However, the advertisement providing system 1100 may prevent the incurrence of advertising costs immaterial to advertising effects caused by an inadvertent touch gesture input by the user and may acquire a more valid effective click input by the user, by recognizing a predetermined touch gesture, other than a simple touch, on an advertising area, and providing additional advertisement information based on the recognized touch gesture.

FIG. 12 is a flowchart illustrating an advertisement providing method according to an exemplary embodiment of the present invention. The advertisement providing method according to this exemplary embodiment may be performed by the advertisement providing system 1100 of FIG. 11.

In operation 1210, the advertisement providing system 1100 may receive an advertisement and may display the advertisement on a touch display. In this instance, the advertisement may be received from an advertising platform or a publisher. For example, the advertisement received from the publisher may be displayed in the advertising area of a page of the publisher, and the advertisement received from the advertising platform may be displayed in the advertising area of an application installed in the advertisement providing system 1100.

In operation 1220, the advertisement providing system 1100 may recognize a touch gesture generated on the touch display. Here, at least part of the touch gesture may include a touch drag in a predetermined direction. That is, a touch drag in a predetermined direction usually demonstrates that the user action was taken by the user more deliberately than a simple touch. Accordingly, the possibility of the user action occurring as a result of an inadvertent input by the user is relatively low with respect to a touch gesture. Also, the touch gesture may be limited to a touch gesture generated on a particular advertising area of the advertisement displayed on the touch display. In general, the touch gesture may include a touch gesture generated over the entire area of the touch display. However, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of the touch gesture, and the at least one piece of location information, direction information, and type information may be displayed on the touch display along with the advertisement. For example, the user interface 340 of FIG. 3 may display location information for starting the touch gesture, such as, the button 350, direction information such as the arrow, and type information. That is, the arrow may indicate a touch drag to the right.

In operation 1230, the advertisement providing system 1100 may display additional advertisement information of the advertisement on the touch display based on the recognized touch gesture. Here, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus will not be repeated here for conciseness.

Also, the additional advertisement information may be displayed to be in motion on the touch display, based on at least one value of a direction, an intensity, a speed, and an acceleration of the recognized touch gesture. In this case, the additional advertisement information may be displayed in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out, and the previous service display may appear again.

When the additional advertisement information is displayed through the advertisement providing method, the advertising cost may be charged to the advertiser of the advertisement for displaying the additional advertisement information based on the recognized touch gesture. That is, the advertising cost may only be charged for displaying advertisement information based on a touch gesture accepted as an effective click. As another example, the additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture is likely an advertisement selected more deliberately by the user, a higher advertising cost may be charged in response to recognizing a touch gesture.

As described in the foregoing, a conventional landing page of an advertiser may be provided in response to a simple touch on the advertising area. In this case, however, due to the characteristics of a touch display, an issue may be raised regarding the high possibility of a touch unwanted by the user, the advertiser, or both that may have been generated inadvertently by the user. However, the advertisement providing system 1100 may prevent the incurrence of advertising costs immaterial to advertising effects caused by an inadvertent touch gesture input by the user and may acquire a more valid effective click input by the user, by recognizing a predetermined touch gesture, other than a simple touch, on an advertising area, and providing additional advertisement information based on the recognized touch gesture.

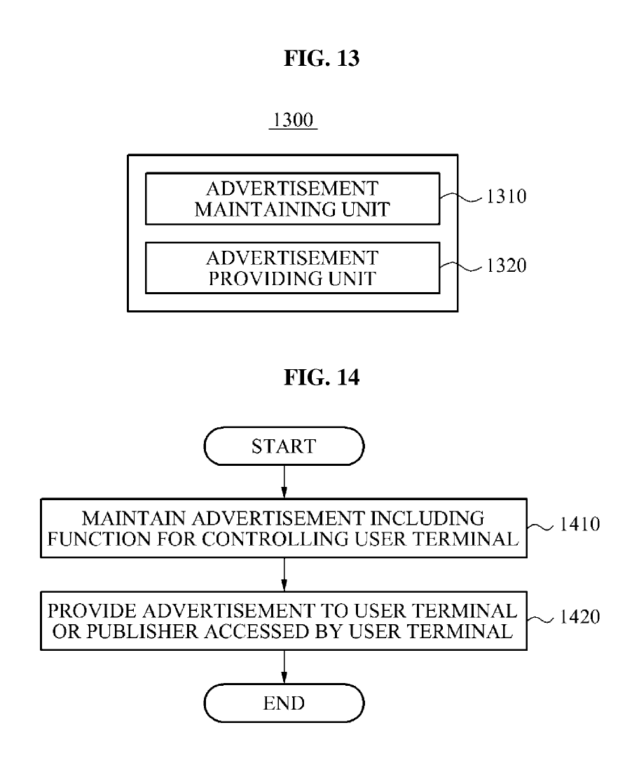

FIG. 13 is a block diagram illustrating an internal configuration of an advertisement providing system 1300 according to another exemplary embodiment of the present invention. The advertisement providing system 1300 according to this exemplary embodiment may correspond to the advertising platform 220 of FIG. 2. The advertisement providing system 1300 may include an advertisement maintaining unit 1310 and an advertising providing unit 1320.

The advertisement maintaining unit 1310 may maintain an advertisement including a function for controlling a user terminal. Here, when the advertisement is displayed on the touch display of the user terminal, the function for controlling the user terminal may include a function for controlling the user terminal to display additional advertisement information of the advertisement by recognizing a touch gesture generated on the touch display.

In this instance, at least part of the touch gesture may include a touch drag in a predetermined direction. That is, a touch drag in a predetermined direction usually demonstrates that the user action was taken by the user more deliberately than a simple touch. Accordingly, the possibility of the user action occurring as a result of an inadvertent input by the user is relatively low with respect to a touch gesture. Also, the touch gesture may be limited to a touch gesture generated on a particular advertising area of the advertisement displayed on the touch display. In general, the touch gesture may include a touch gesture generated over the entire area of the touch display. However, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of the touch gesture, and the at least one piece of location information, direction information, and type information may be displayed on the touch display of the user terminal along with the advertisement. For example, the user interface 340 of FIG. 3 may display location information for starting the touch gesture, such as, the button 350, direction information such as the arrow, and type information. That is, the arrow may indicate a touch drag in the direction to the right.

Also, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus, will not be repeated here for conciseness.

In this instance, the additional advertisement information may be displayed to be in motion on the touch display, based on at least one value of a direction, an intensity, a speed, and an acceleration of the recognized touch gesture. In this case, the additional advertisement information in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out and the previous service display may appear again.

The advertisement providing unit 1320 may provide the advertisement to the user terminal or a publisher accessed by the user terminal. That is, the advertisement may be transmitted from the advertisement providing system 1300 to the user terminal directly or through the publisher. For example, the advertisement received through the publisher may be displayed in the advertising area of a page of the publisher, and the advertisement received from the advertising platform may be displayed in the advertising area of an application installed in the user terminal.

When the additional advertisement information is displayed on the touch display of the user terminal, an advertising cost may be charged to the advertiser of the advertisement for displaying the additional advertisement information based on the recognized touch gesture. That is, the advertising cost may only be charged for displaying advertisement information based on a touch gesture accepted as an effective click.

As another example, the additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture is likely an advertisement selected more deliberately by the user, a higher advertising cost may be charged in response to recognizing a touch gesture.

As described in the foregoing, a conventional landing page of an advertiser may be provided in response to a simple touch on the advertising area. In this case, however, due to the characteristics of a touch display, an issue may be raised regarding the high possibility that a touch unwanted by the user, the advertiser, or both may be generated inadvertently by the user. However, the advertisement providing system 1300 may prevent the incurrence of advertising costs immaterial to advertising effects caused by an inadvertent touch gesture input by the user and may acquire a more valid effective click input by the user, by providing, through the advertisement, a function for controlling the user terminal to recognize a predetermined touch gesture, other than a simple touch, on an advertising area and to provide additional advertisement information based on the recognized touch gesture.

FIG. 14 is a flowchart illustrating an advertisement providing method according to another exemplary embodiment of the present invention. The advertisement providing method according to this exemplary embodiment may be performed by the advertisement providing system 1300 of FIG. 13.

In operation 1410, the advertisement providing system 1300 may maintain an advertisement including a function for controlling a user terminal. Here, when the advertisement is displayed on a touch display of the user terminal, the function for controlling the user terminal may include a function for controlling the user terminal to display additional advertisement information of the advertisement by recognizing a touch gesture generated on the touch display.

In this instance, at least part of the touch gesture may include a touch drag input that is made in a predetermined direction. That is, a touch drag input in a predetermined direction tends to indicate that the user action was made by the user more deliberately than a simple touch. Accordingly, the possibility of the user action occurring as a result of an inadvertent input by the user is relatively low. Also, the touch gesture may be limited to a touch gesture generated on a particular advertising area of the advertisement displayed on the touch display. In general, the touch gesture may include a touch gesture generated over the entire area of the touch display. However, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of the touch gesture, and the at least one piece of location information, direction information, and type information may be displayed on the touch display of the user terminal along with the advertisement. For example, the user interface 340 of FIG. 3 may display location information for starting the touch gesture, such as, the button 350, direction information such as the arrow, and type information. That is, the arrow may indicate a touch drag in the direction to the right.

Also, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus will not be repeated here for conciseness.

In this instance, the additional advertisement information may be displayed to be in motion on the touch display, based on at least one value of a direction, an intensity, a speed, and an acceleration of the recognized touch gesture. In this case, the additional advertisement information may be displayed in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out and the previous service display may appear again.

In operation 1420, the advertisement providing system 1300 may provide the advertisement to the user terminal or a publisher accessed by the user terminal. That is, the advertisement may be transmitted from the advertisement providing system 1300 to the user terminal directly or through the publisher. For example, the advertisement received through the publisher may be displayed in the advertising area of a page of the publisher, and the advertisement received from the advertising platform may be displayed in the advertising area of an application installed in the user terminal.

When the additional advertisement information is displayed on the touch display of the user terminal, the advertising cost may be charged to the advertiser of the advertisement for displaying the additional advertisement information based on the recognized touch gesture. That is, the advertising cost may only be charged for displaying advertisement information based on a touch gesture accepted as an effective click.

As another example, the additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture tends to be an advertisement selected more deliberately by the user, a higher advertising cost may be charged in response to recognizing a touch gesture.

As described in the foregoing, a conventional landing page of an advertiser may be provided in response to a simple touch on the advertising area. In this case, however, due to the characteristics of a touch display, an issue may be raised regarding the high possibility a touch unwanted by the user, the advertiser, or both may be generated inadvertently by the user. However, the advertisement providing system 1300 may prevent the incurrence of advertising costs immaterial to advertising effects caused by an inadvertent touch gesture input by the user and may acquire a more valid effective click input by the user, by providing, through the advertisement, a function for controlling the user terminal to recognize a predetermined touch gesture, other than a simple touch, on an advertising area, and to provide additional advertisement information based on the recognized touch gesture.

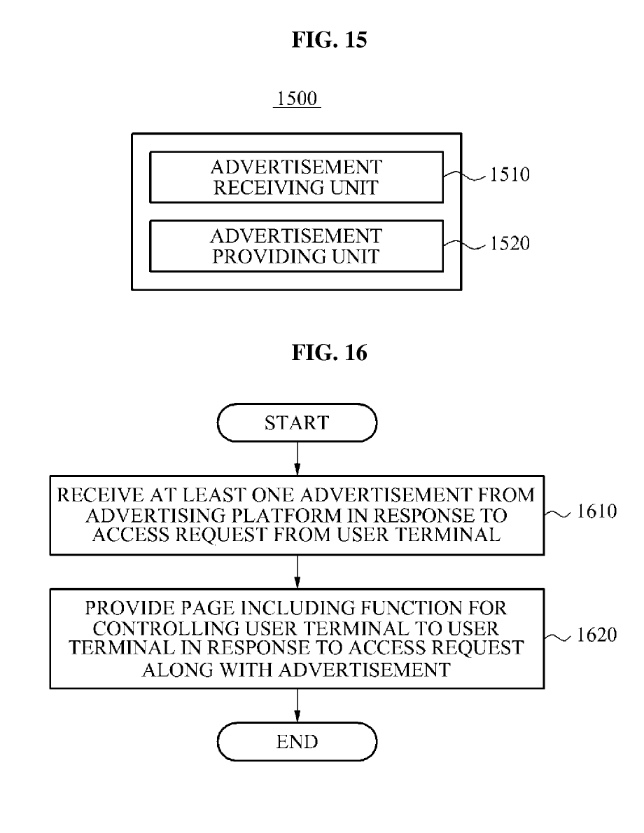

FIG. 15 is a block diagram illustrating an internal configuration of an advertisement providing system 1500 according to still another exemplary embodiment of the present invention. The advertisement providing system 1500 according to this exemplary embodiment may correspond to the publisher 230 of FIG. 2. The advertisement providing system 1500 may include an advertisement receiving unit 1510 and an advertisement providing unit 1520.

The advertisement receiving unit 1510 may receive at least one advertisement from an advertising platform in response to an access request from a user terminal. That is, the advertisement providing system 1500 may provide a predetermined page to the user terminal requesting access, and may display an advertisement on the predetermined page. In this instance, the advertisement receiving unit 1510 may receive advertisements to be displayed on the predetermined page from an advertising platform.

The advertisement providing unit 1520 may provide the user terminal with a page including a function for controlling the user terminal along with the advertisement in response to the access request. Here, when the advertisement is displayed on a touch display of the user terminal, the function for controlling the user terminal may include a function for controlling the user terminal to display additional advertisement information of the advertisement by recognizing a touch gesture generated on the touch display.

In this instance, at least part of the touch gesture may include a touch drag input in a predetermined direction. That is, a touch drag in a predetermined direction tends to indicate that the user action was taken by the user more deliberately than a simple touch. Accordingly, the possibility of the user action occurring as a result of an inadvertent input by the user is relatively low with respect to a touch gesture. Also, the touch gesture may be limited to a touch gesture generated on a particular advertising area of the advertisement displayed on the touch display. In general, the touch gesture may include a touch gesture generated over the entire area of the touch display. However, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of the touch gesture, and the at least one piece of location information, direction information, and type information may be displayed on the touch display of the user terminal along with the advertisement. For example, the user interface 340 of FIG. 3 may display location information for starting the touch gesture, such as, the button 350, direction information such as the arrow, and type information. That is, the arrow may indicate a touch drag in the direction to the right.

Also, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus, will not be repeated here for conciseness.

In this instance, the additional advertisement information may be displayed to be in motion on the touch display, based on at least one value of a direction, an intensity, a speed, and an acceleration of the recognized touch gesture. In this case, the additional advertisement information in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out and the previous service display may appear again.

When the additional advertisement information is displayed on the touch display of the user terminal, an advertising cost may be charged to the advertiser of the advertisement for displaying the additional advertisement information based on the recognized touch gesture. That is, the advertising cost may only be charged for displaying advertisement information based on a touch gesture accepted as an effective click.

As another example, the additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture is likely an advertisement selected more deliberately by the user, a higher advertising cost may be charged in response to recognizing a touch gesture.

As described in the foregoing, a conventional landing page of an advertiser may be provided in response to a simple touch on the advertising area. In this case, however, due to the characteristics of a touch display, an issue may be raised regarding the high possibility that a touch unwanted by the user, the advertiser, or both that may be generated inadvertently by the user. However, the advertisement providing system 1500 may prevent the incurrence of advertising costs immaterial to advertising effects caused by an inadvertent input by the user and may acquire a more valid effective click from the user, by providing, through the page provided to the user terminal, a function for controlling the user terminal to recognize a predetermined touch gesture, rather than a simple touch, on an advertising area, and to provide additional advertisement information based on the touch gesture.

FIG. 16 is a flowchart illustrating an advertisement providing method according to still another exemplary embodiment of the present invention. The advertisement providing method according to this exemplary embodiment may be performed by the advertisement providing system 1500 of FIG. 15.

In operation 1610, the advertisement providing system 1500 may receive at least one advertisement from an advertising platform in response to an access request from a user terminal. That is, the advertisement providing system 1500 may provide a predetermined page to the user terminal requesting access, and may display an advertisement on the predetermined page. For the advertisement providing system 1500 to provide a predetermined page to a user terminal requesting access and display an advertisement through the predetermined page. In this instance, the advertisement providing system 1500 may receive advertisements to be displayed on the predetermined page from an advertising platform.

In operation 1620, the advertisement providing system 1500 may provide the user terminal with a page including a function for controlling the user terminal along with the advertisement in response to the access request. Here, when the advertisement is displayed on a touch display of the user terminal, the function for controlling the user terminal may include, a function for controlling the user terminal to display additional advertisement information of the advertisement by recognizing a touch gesture generated on the touch display.

In this instance, at least part of the touch gesture may include a touch drag input in a predetermined direction. That is, a touch drag in a predetermined direction tends to indicate that the user action was taken by the user more deliberately than a simple touch. Accordingly, the possibility of the user action occurring as a result of an inadvertent input by the user is relatively low with respect to a touch gesture. Also, the touch gesture may be limited to a touch gesture generated on a particular advertising area of the advertisement displayed on the touch display. In some instances, the touch gesture may include a touch gesture generated over the entire area of the touch display. However, in other instances, selecting a predetermined advertisement among a plurality of advertisements may be limited to a touch gesture generated on the advertising area of the corresponding predetermined advertisement.

In this instance, the advertisement may include at least one piece of location information, direction information, and type information for inducing the generation of the touch gesture, and the at least one piece of location information, direction information, and type information may be displayed on the touch display of the user terminal along with the advertisement. For example, the user interface 340 of FIG. 3 may display location information for starting the touch gesture, such as, the button 350, direction information such as the arrow, and type information. That is, the arrow may indicate a touch drag in the direction to the right.

Also, the additional advertisement information may include at least one of a video associated with the advertisement, a landing page associated with the advertisement, location information associated with the advertisement, information about a click-to-call service providing a call to a telephone number associated with the advertisement, information about a service providing an application associated with the advertisement, and information about an SNS associated with the advertisement. That is, various forms of advertisement information may be provided to the user based on additional advertisement information set for the corresponding advertisement, while the touch gesture is the same. A detailed description of various forms of advertisement information has been already provided in the disclosure about the link option described with reference to FIG. 8 and FIG. 9 and thus, will not be repeated here for conciseness.

In this instance, the additional advertisement information may be displayed to be in motion on the touch display, based on at least one value of a direction, an intensity, a speed, and an acceleration of the recognized touch gesture. In this case, the additional advertisement information in a manner that a moving piece of the additional advertisement information overlays the service display being currently displayed, or may be displayed in a manner that a piece of the additional advertisement information moves in to push out the service display. Also, when another touch drag occurs on the area in which the advertisement information is displayed, the advertisement information may fade out and the previous service display may appear again.

When the additional advertisement information is displayed on the touch display of the user terminal, an advertising cost may be charged to the advertiser of the advertisement for displaying the additional advertisement information based on the recognized touch gesture. That is, the advertising cost may only be charged for displaying advertisement information based on a touch gesture accepted as an effective click.

As another example, the additional advertisement information may be displayed on the touch display when a touch generated on the advertising area is recognized. In this case, the advertising cost incurred by recognizing the touch may be different from the advertising cost incurred by recognizing the touch gesture. For example, since an advertisement selected through recognition of a touch gesture is likely an advertisement selected more deliberately by the user, a higher advertising cost may be charged in response to recognizing a tough gesture.

As described in the foregoing, a conventional landing page of an advertiser may be provided in response to a simple touch on the advertising area. In this case, however, due to the characteristics of a touch display, an issue may be raised regarding the high possibility that an unwanted touch by the user, the advertiser, or both that may be generated inadvertently by the user. However, the advertisement providing system 1500 may prevent the incurrence of advertising costs immaterial to advertising effects caused by an inadvertent input by the user and acquire a more valid effective click from the user, by providing, through the page provided to the user terminal, a function for controlling the user terminal to recognize a predetermined touch gesture, rather than a simple touch, on an advertising area and to provide additional advertisement information based on the recognized touch gesture.

A reference may be made to FIGS. 2 through 10 for the disclosure omitted in FIGS. 11 through 16.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard discs, floppy discs, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to function as one or more software modules in order to perform the operations of the above-described embodiments of the present invention.

According to the exemplary embodiments of the present invention, selection of an advertisement by a user may be recognized using a touch gesture such as a touch drag, but not a simple touch, on an advertising area. Also, when selection of the advertisement by the user is recognized, beyond simply providing an advertising page, advertisement information based on a predetermined action set for a touch gesture may be provided, and an advertising cost may be charged differently based on an advertisement selection model used. Furthermore, advertisement information including various link options, such as, for example, a video link, an application store link, a webpage link, an SNS link, and the like, may be provided for one advertisement, and to arouse interests of the user, individual link options selected by the user may be tracked and a link option attracting a high interest from the user may be continuously provided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a touch display to provide advertisements, the method comprising:
displaying an advertisement on the touch display;
sensing a touch gesture applied to the touch display; and
displaying additional advertisement information associated with the advertisement on the touch display based on the sensed touch gesture.

2. The method of claim 1, wherein at least part of the touch gesture comprises a touch drag in a first direction.

3. The method of claim 1, wherein the touch gesture comprises a touch gesture applied to an advertising area of the advertisement displayed on the touch display.

4. The method of claim 1, wherein the additional advertisement information is displayed to be in motion on the touch display, based on at least one value of a direction, an intensity, a speed, and an acceleration of the recognized touch gesture.

5. The method of claim 1, wherein the additional advertisement information comprises at least one of a video associated with the advertisement, a landing page associated with the advertisement, location information associated with the advertisement, information relating to a click-to-call service providing a call to a telephone number associated with the advertisement, information relating to a service providing an application associated with the advertisement, and information relating to a social networking service associated with the advertisement.

6. The method of claim 1, wherein the advertisement comprises at least one piece of location information, direction information, and type information for inducing the touch gesture, and
the at least one piece of location information, direction information, and type information is displayed on the touch display along with the advertisement.

7. The method of claim 1, further comprising associating the displaying of the additional advertisement information as a first chargeable event for an advertiser of the advertisement based on the sensed touch gesture.

8. The method of claim 7, further comprising:
displaying the additional advertisement information on the touch display in response to sensing a touch applied to the advertising area of the advertisement,
associating the additional advertisement information in response to sensing the touch with a second chargeable event where an advertising cost is different from the first chargeable event.

9. An advertisement providing system comprising:
an advertisement maintaining unit configured to maintain an advertisement comprising a function for controlling a user terminal;
a data storage device to store information of the advertisement; and
an advertisement providing unit configured to provide the advertisement to the user terminal or a publisher accessed by the user terminal,
wherein the function is provided to, in response to the advertisement being displayed on a touch display of the user terminal, control the user terminal to display additional advertisement information of the advertisement by sensing a touch gesture applied to the touch display.

10. The system of claim 9, wherein at least part of the touch gesture comprises a touch drag in a first direction.

11. The system of claim 9, wherein the touch gesture comprises a touch gesture applied to an advertising area of the advertisement displayed on the touch display.

12. The system of claim 9, wherein the additional advertisement information is displayed to be in motion on the touch display, based on at least one value of a direction, an intensity, a speed, and an acceleration of the recognized touch gesture.

13. The system of claim 9, wherein the additional advertisement information comprises at least one of a video associated with the advertisement, a landing page associated with the advertisement, location information associated with the advertisement, information relating to a click-to-call service providing a call to a telephone number associated with the advertisement, information relating to a service providing an application associated with the advertisement, and information relating to a social networking service associated with the advertisement.

14. The system of claim 9, wherein the advertisement comprises at least one piece of location information, direction information, and type information for inducing the touch gesture, and
the at least one piece of location information, direction information, and type information is displayed on the touch display along with the advertisement.

15. The system of claim 9, wherein the function is further provided to associate the displaying of the additional advertisement information as a first chargeable event for an advertiser of the advertisement based on the sensed touch gesture.

16. The system of claim 15, wherein the function is further provided to display the additional advertisement information on the touch display in response to sensing a touch applied to the advertising area of the advertisement, and to associate the additional advertisement information in response to sensing the touch with a second chargeable event where an advertising cost is different from the first chargeable event.

17. An advertisement providing system comprising:
an advertisement receiving unit configured to receive at least one advertisement from an advertising platform in response to an access request from a user terminal;
a data storage device to store information of the at least one advertisement; and
an advertisement providing unit configured to provide the user terminal with a page comprising a function for controlling the user terminal along with the advertisement in response to the access request,
wherein the function is provided to, in response to the advertisement being displayed on a touch display of the user terminal, control the user terminal to display additional advertisement information of the advertisement by sensing a touch gesture applied to the touch display.

18. The system of claim 17, wherein the advertisement comprises at least one piece of location information, direction information, and type information for inducing the touch gesture, and
the at least one piece is displayed on the touch display along with the advertisement.

19. The system of claim 17, wherein the function is further provided to associate the displaying of the additional advertisement information as a first chargeable event for an advertiser of the advertisement based on the sensed touch gesture.

20. The system of claim 19, wherein the function is further provided to display the additional advertisement information on the touch display in response to sensing a touch applied to an advertising area of the advertisement, and to associate the additional advertisement information in response to sensing the touch with a second chargeable event where an advertising cost is different from the first chargeable event.
